(19) United States
(12) Patent Application Publication
(10) Pub. No.: US 2019/0293927 A1
(43) Pub. Date: Sep. 26, 2019

(54) OPTICAL DEFLECTOR

(71) Applicant: OLYMPUS CORPORATION, Tokyo (JP)

(72) Inventor: Naoki SHIRAISHI, Hino-shi (JP)

(73) Assignee: OLYMPUS CORPORATION, Tokyo (JP)

(21) Appl. No.: 16/438,745

(22) Filed: Jun. 12, 2019

Related U.S. Application Data
(63) Continuation of application No. PCT/JP2016/087411, filed on Dec. 15, 2016.

(51) Int. Cl. G02B 26/10

(52) U.S. Cl. CPC G02B 26/105

(57) ABSTRACT

An optical deflector includes a movable portion having a reflecting surface, an elastic member configured to swingably support the movable portion about a swinging axis, and a support portion configured to support the elastic member. The movable portion includes a first movable plate including the reflecting surface, and a second movable plate including a driving force generating surface. The first movable plate includes at least one first rib formed on a back surface of the reflecting surface. The second movable plate includes at least one second rib formed on a back surface of the driving force generating surface. The first rib and the second rib are configured to intersect each other. Part of the first rib and part of the second rib are bonded.

### CROSS-REFERENCE TO RELATED APPLICATIONS

This application is a Continuation Application of PCT Application No. PCT/JP2016/087411, filed Dec. 15, 2016, the entire contents of which are incorporated herein by reference.

### BACKGROUND OF THE INVENTION

### 1. Field of the Invention

The present invention relates to an optical deflector in which a movable portion having a reflecting surface is swingably supported by beams formed by elastic members, and the movable portion is swung about a torsion axis of the beams, which causes change of an orientation of the reflecting surface to change a direction of a light beam reflected by the reflecting surface.

### 2. Description of the Related Art

An optical deflector that is made by using a micromachine technique is gaining attention. The micromachine technique is a micromachining technique based on a semiconductor manufacturing technique, and is superior in that the micromachine technique enables miniaturization and mass production at low cost. In recent years, it tends to be demanded to make a scan speed of a light beam of optical deflectors higher. When the scan speed is made higher, kinetic energy of a movable portion of an optical deflector increases, and therefore there is one problem that a dynamic strain of a reflecting surface during driving increases, and a beam spot shape deteriorates.

### BRIEF SUMMARY OF THE INVENTION

An optical deflector includes a movable portion having a reflecting surface, an elastic member configured to swingably support the movable portion about a swinging axis, and a support portion configured to support the elastic member. The movable portion includes a first movable plate including the reflecting surface, and a second movable plate including a driving force generating surface. The first movable plate includes at least one first rib formed on a back surface of the reflecting surface. The second movable plate includes at least one second rib formed on a back surface of the driving force generating surface. The first rib and the second rib are configured to intersect each other. Part of the first rib and part of the second rib are bonded.

Advantages of the invention will be set forth in the description that follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an upper surface perspective view illustrating a basic configuration of an optical deflector.

FIG. 2 is a lower surface perspective view illustrating the basic configuration of the optical deflector according to an electromagnetic driving system.

FIG. 3 is a lower surface perspective view illustrating the basic configuration of the optical deflector according to an electrostatic driving system.

FIG. 4 is an upper surface perspective view illustrating a configuration of one example of an optical deflector according to a first embodiment.

FIG. 5 is a lower surface perspective view illustrating a configuration of an example of a first movable plate of the optical deflector according to the first embodiment.

FIG. 6 is an upper surface perspective view illustrating a configuration of an example of a second movable plate of the optical deflector according to the first embodiment.

FIG. 7 is an upper surface perspective view illustrating a configuration of an example of an optical deflector according to a second embodiment.

FIG. 8 is a lower surface perspective view illustrating a configuration of an example of a first movable plate of the optical deflector according to the second embodiment.

FIG. 9 is an upper surface perspective view illustrating a configuration of one example of a second movable plate of the optical deflector according to the second embodiment.

FIG. 10 is an upper surface perspective view illustrating a configuration of an example of an optical deflector according to a third embodiment.

FIG. 11 is a lower surface perspective view illustrating a configuration of an example of a first movable plate of the optical deflector according to the third embodiment.

FIG. 12 is an upper surface perspective view illustrating a configuration of an example of a second movable plate of the optical deflector according to the third embodiment.

FIG. 13 is a view illustrating rib structures of some movable portions.

FIG. 14 is a view illustrating rigidity of movable portions of the rib structures illustrated in FIG. 13.

FIG. 15 is an upper surface view illustrating a configuration of an example of an optical deflector according to a fourth embodiment.

FIG. 16 is a lower surface perspective view illustrating a configuration of an example of a first movable plate of the optical deflector according to the fourth embodiment.

FIG. 17 is an upper surface perspective view illustrating a configuration of an example of a second movable plate of the optical deflector according to the fourth embodiment.

### DETAILED DESCRIPTION OF THE INVENTION

A function and an effect of a configuration of an optical deflector according to the present embodiment will be described. In addition, this embodiment does not limit the present invention. That is, description of the embodiment includes a large amount of specific detailed contents for exemplary description. However, even when some variations and changes are added to these detailed contents, the detailed contents does not exceed the scope of the present invention. Hence, the exemplary embodiments of the present invention described below will be described without losing generality of the claimed Invention and Limiting the Claimed Invention.

(Basic Configuration of Optical Deflector)

Prior to description of the embodiments of the present invention, a basic configuration of an optical deflector to which each embodiment is applicable will be described first with reference to the drawings.

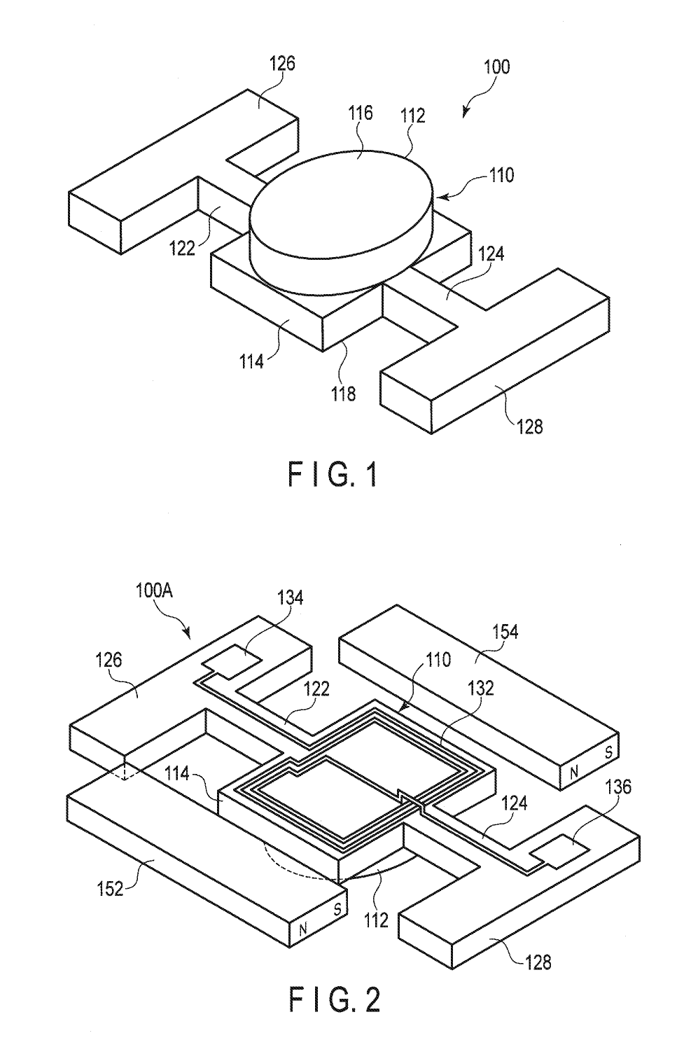

As illustrated in FIG. 1, an optical deflector 100 includes a movable portion 110 having a reflecting surface 116, a pair of elastic members 122 and 124 configured to swingably support the movable portion 110, and support portions 126 and 128 supporting the elastic members 122 and 124. The elastic members 122 and 124 have square cross sections, and symmetrically extend from the movable portion 110 to both sides. Hence, the movable portion 110 is swingably supported about a swinging axis passing inside the elastic members 122 and 124 with respect to the support portions 126 and 128.

The movable portion 110 includes a first movable plate 112 having the reflecting surface 116, and a second movable plate 114 having a driving force generating surface 118. A side surface of the first movable plate 112 is perpendicular to the reflecting surface 116. A side surface of the second movable plate 114 is perpendicular to the driving force generating surface 118. The reflecting surface 116 has a smaller area than the driving force generating surface 118.

The driving force generating surface 118 of the second movable plate 114 is provided with a driving force generating member for swinging the movable portion 110. The driving force generating member differs according to a driving system of the optical deflector 100. For example, in a case of an electromagnetic driving system, the driving force generating member is a drive coil running around a rim of the movable portion 110. In a case of an electrostatic driving system, the driving force generating member is a pair of drive electrodes expanding in a substantially entire surface of the movable portion 110.

The driving force generating surface 118 has a rectangular outline, and the reflecting surface 116 has an elliptical outline. For example, the driving force generating surface 118 is long in a direction perpendicular to the swinging axis, and the reflecting surface 116 has a major axis in the direction perpendicular to the swinging axis. The elliptical shape of the reflecting surface 116 more preferably has the outline that is substantially inscribed in the rectangle of the driving force generating surface 118.

A connection portion of the elastic members 122 and 124 and the second movable plate 114, and a connection portion of the elastic members 122 and 124 and the support portions 126 and 128 are rounded (R) to prevent concentration of a stress.

This optical deflector 100 is formed from a single crystal silicon substrate by using, for example, a semiconductor process. The single crystal silicon has high rigidity, and causes little internal damping of a material, and therefore is suitable for a material of the elastic members 122 and 124 for resonant driving, and is suitable for a material of the support portions 126 and 128, too, which are adhered to an external member.

(Electromagnetic Driving Type Optical Deflector)

As described above, the driving force generating member provided to the second movable plate 114 differs according to a driving system of the optical deflector 100. FIG. 2 illustrates a basic configuration of an optical deflector 100A according to the electromagnetic driving system. FIG. 2 schematically illustrates a layout of the drive coil, which is the driving force generating member provided to the movable portion 110, and omits illustration of an insulation film that protects the drive coil and other members.

As illustrated in FIG. 2, the optical deflector 100A includes a drive coil 132 running around a periphery portion of the movable portion 110. One end portion of the drive coil 132 extends on the elastic member 122, and is electrically connected with an electrode pad 134 provided on the support portion 126. Furthermore, the other end portion of the drive coil 132 jumps over the portion running around the periphery portion of the movable portion 110, extends on the elastic member 124, and is electrically connected with an electrode pad 136 provided on the support portion 128.

Near the electromagnetically driving type optical deflector 100A, a pair of permanent magnets 152 and 154 is provided. The permanent magnets 152 and 154 are disposed near both sides of the movable portion 110 and in substantially parallel to the swinging axis. Magnetization directions of the permanent magnets 152 and 154 are mutually the same direction, and are substantially parallel to the driving force generating surface 118 of the movable portion 110 in a static state. The permanent magnets 152 and 154 generate magnetic fields in a direction within the driving force generating surface 118 of the movable portion 110 and substantially perpendicular to the swinging axis with respect to a portion of the drive coil 132 located on both side portions of the movable portion 110.

Application of alternating current voltages to the two electrode pads 134 and 136 on the support portions 126 and 128 causes an alternating current to flows to the drive coil 132. The current flowing at portions close to the permanent magnets 152 and 154 of the drive coil 132 receives a Lorentz force due to an interaction with the magnetic fields generated by the permanent magnets 152 and 154. As a result, the movable portion 110 receives a couple whose direction periodically switches in response to application of an alternating current voltage in a plate thickness direction. Hence, the movable portion 110 swings, i.e., vibrates about the swinging axis extending in a longitudinal direction of the two elastic members 122 and 124. As a result, a light beam reflected by the reflecting surface provided to the movable portion 110 is periodically deflected at a certain angular width.

(Electrostatic Driving Optical Deflector)

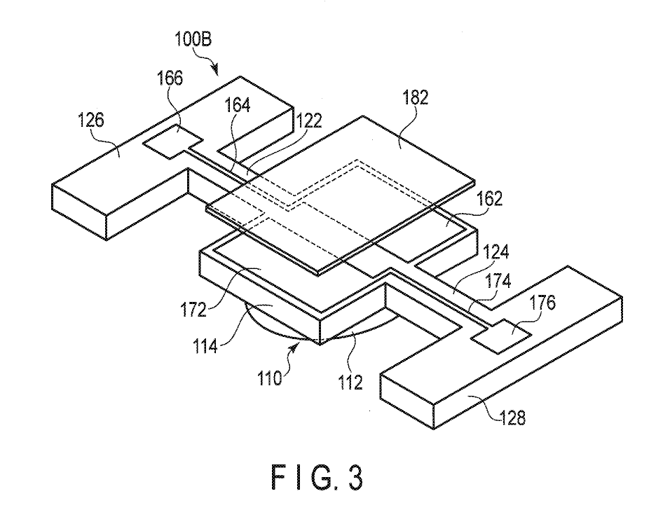

Furthermore, FIG. 3 illustrates a basic configuration of an optical deflector 100B according to the electrostatic driving system. FIG. 3 schematically illustrates a layout of the pair of drive electrodes, which is the driving force generating member provided to the movable portion 110, and omits illustration of an insulation film that protects the drive electrode and other members.

As illustrated in FIG. 3, the movable portion 110 of the optical deflector 100B includes a pair of drive electrodes 162 and 172. The drive electrodes 162 and 172 have the same shape, are disposed symmetrically with respect to the swinging axis, and expand on the substantially entire driving force generating surface 118. The drive electrode 162 is electrically connected with an electrode pad 166 provided to the support portion 126 through a wiring 164 extending on the elastic member 122. The drive electrode 172 is electrically connected with an electrode pad 176 provided to the support portion 128 through a wiring 174 extending on the elastic member 124.

As illustrated in FIG. 3, the electrostatic driving type optical deflector 100B is provided with a fixed electrode 182 facing the drive electrodes 162 and 172 provided to the movable portion 110. The fixed electrode 182 is fixed to an unillustrated member, and is supported in a certain direction.

The fixed electrode 182 is kept at, for example, a ground potential, and the drive electrodes 162 and 172 are alternately applied a predetermined potential through the corresponding electrode pads 166 and 176. Thus, the drive electrodes 162 and 172 receive an electrostatic attraction corresponding to a potential difference between each of the drive electrodes 162 and 172 and the fixed electrode 182. As a result, the movable portion 110 receives a couple whose direction periodically switches in response to alternate application of a potential in the plate thickness direction. Hence, the movable portion 110 swings, i.e., vibrates about the swinging axis extending in a longitudinal direction of the two elastic members 122 and 124. As a result, a light beam reflected by the reflecting surface provided to the movable portion 110 is periodically deflected at a certain angular width.

### First Embodiment

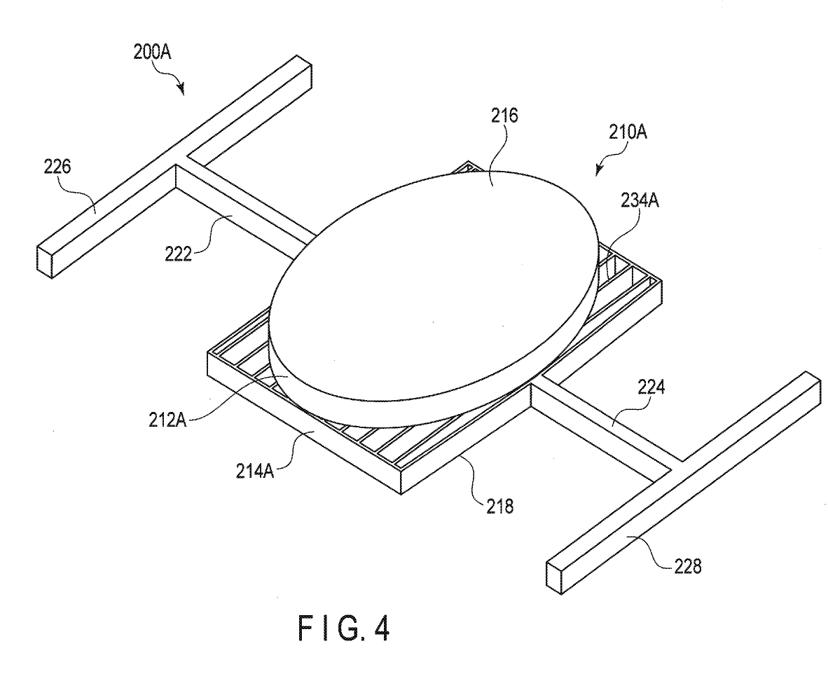

Next, an optical deflector according to the first embodiment will be described. FIGS. 4 to 6 are views illustrating a perspective configuration of the optical deflector according to the first embodiment. First, the configuration will be described. As illustrated in FIG. 4, an optical deflector 200A includes at least a movable portion 210A having a reflecting surface 216, elastic members 222 and 224 configured to swingably support the movable portion 210A about a swinging axis, and support portions 226 and 228 supporting the elastic members 222 and 224. The movable portion 210A includes a first movable plate 212A having the reflecting surface 216, and a second movable plate 214A having a driving force generating surface 218. The first movable plate 212A and the second movable plate 214A are bonded such that the reflecting surface 216 of the first movable plate 212A and the driving force generating surface 218 of the second movable plate 214A are disposed outside on the opposite sides. The reflecting surface 216 and the driving force generating surface 218 preferably each have high flatness.

The movable portion 210A, the elastic members 222 and 224, and the support portions 226 and 228 each have basically the same function as the movable portion 110, the elastic members 122 and 124, and the support portions 126 and 128 of the optical deflector 100 described above. That is, the optical deflector 200A is replaceable with optical deflectors 100, 100A, and 100B described above. In other words, for example, the drive coil 132 and the electrode pads 134 and 136, or the drive electrodes 162 and 172, the wirings 164 and 164, and the electrode pads 166 and 176 may be provided to the optical deflector 200A according to the driving system.

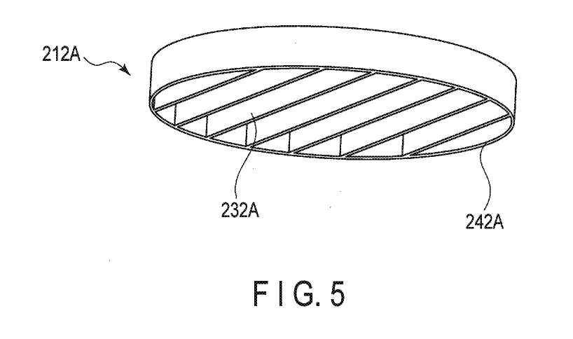

Furthermore, as illustrated in FIG. 5, the first movable plate 212A has the reflecting surface 216 having an elliptical outline, and first ribs 232A that are formed on a back surface of the elliptical reflecting surface 216. The first ribs 232A protrude from the back surface of the reflecting surface 216, and extend in a direction parallel to the swinging axis of the elastic members 222 and 224.

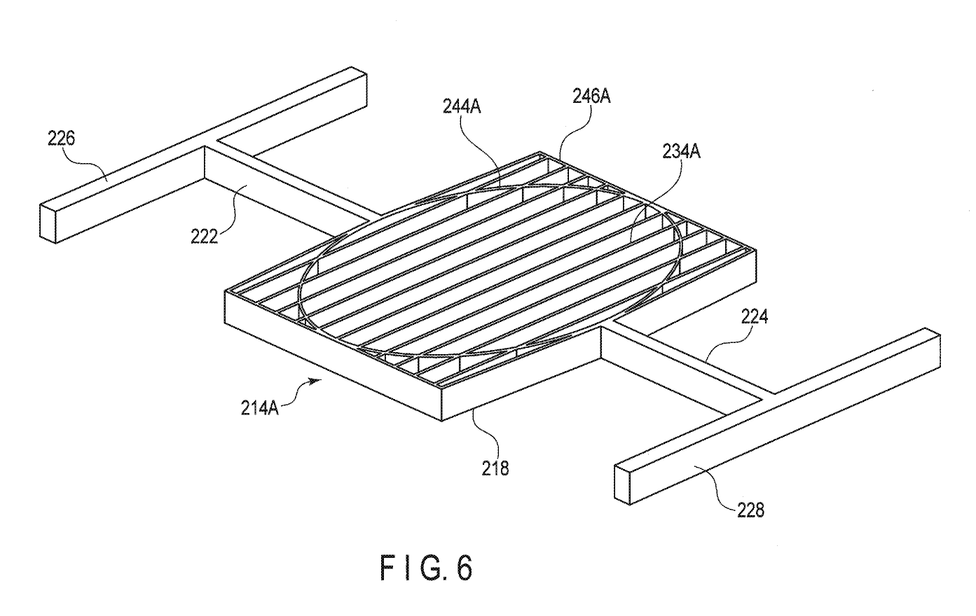

Furthermore, as illustrated in FIG. 6, the second movable plate 214A is formed by the same layer as the elastic members 222 and 224. Furthermore, the second movable plate 214A has the driving force generating surface 218, and second ribs 234A that are formed on the back surface of the driving force generating surface 218. The second ribs 234A protrude from the back surface of the driving force generating surface 218, and extend in a direction perpendicular to the swinging axis of the elastic members 222 and 224.

The first ribs 232A and the second ribs 234A three-dimensionally intersect each other, and part of the first ribs 232A and part of the second ribs 234A are bonded. In this regard, that the two members three-dimensionally intersect each other means that the one member is located above the other member, and extends crossing the other member. Portions of the first ribs 232A and the second ribs 234A at which both cross are bonded.

Furthermore, the first movable plate 212A is a three-dimensional body having an end face that corresponds with an outline shape of the elliptical reflecting surface 216, and has a first frame 242A that is formed at an outer circumference portion of the outline shape. The first frame 242A protrudes from the back surface of the reflecting surface 216 similar to the first ribs 232A.

The second movable plate 214A has a second frame 244A that is bonded with the first frame 242A. That is, the second frame 244A has the same elliptical outline shape as that of the first frame 242A. Furthermore, the second movable plate 214A is a three-dimensional body having an end face that corresponds with a square outline shape, and has a third frame 246A that is formed at an outer circumference portion of the outline shape. The second frame 244A and the third frame 246A protrude from the back surface of the driving force generating surface 218 similar to the second ribs 234A.

In addition, although not illustrated, a driving force generating member such as a drive coil is formed on the driving force generating surface 218.

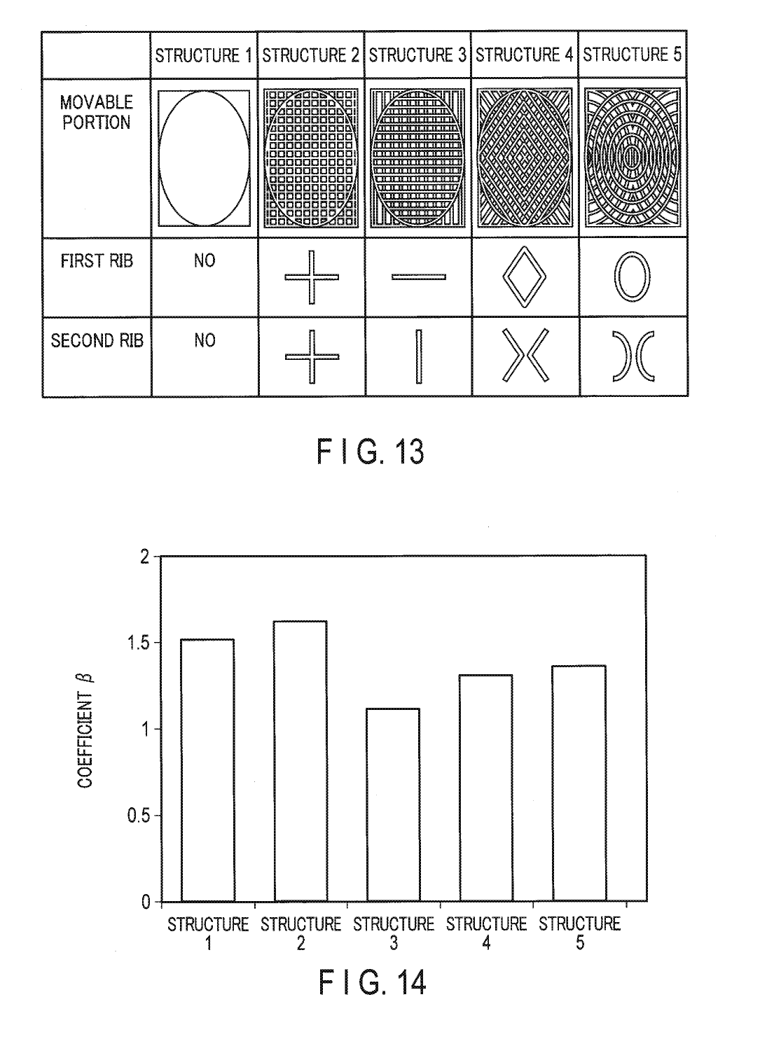

The rib structure and the rigidity of the movable portion will be described below. First, the rib structure of the movable portion will be described. FIG. 13 is a view illustrating rib structures of some movable portions.

A structure 1 corresponds to a solid movable portion in which the first movable plate and the second movable plate each have no rib.

A structure 2 corresponds to a movable portion in which the first movable plate and the second movable plate both have ribs in a lattice pattern. More specifically, the ribs formed in the first movable plate and the second movable plate both extend in both of a direction parallel to the swinging axis of the elastic members and a direction perpendicular to the swinging axis of the elastic members.

A structure 3 corresponds to a movable portion according to the present embodiment. That is, first ribs formed in the first movable plate extend in the direction parallel to the swinging axis of the elastic members, and second ribs formed in the second movable plate extend in the direction perpendicular to the swinging axis of the elastic members.

A structure 4 corresponds to a movable portion according to a second embodiment described below. Although described below in detail, the first ribs formed in the first movable plate extend in directions parallel to lines connecting intersection points of an outer circumference and a major axis of the elliptical reflecting surface and intersection points of the outer circumference and a minor axis of the elliptical reflecting surface. Furthermore, the second ribs formed in the second movable plate extend in directions parallel to diagonal lines of a rectangular shape that is circumscribed about the elliptical reflecting surface.

A structure 5 corresponds to a movable portion according to a third embodiment described below. Although described in detail below, the first ribs formed in the first movable plate extend along concentrically disposed ellipses, and the second ribs formed in the second movable plate extend curvilinearly, i.e., in curved shapes.

Next, an evaluation index of the rigidity of the movable portion will be described. A strain caused by an inertia force of the movable portion is introduced for comparing the rigidity of the movable portions of the unique structures. A strain 5 caused by the inertia force of the movable portion is expressed as equation (1) by a motion equation.

$$δ = α \times ( 1 - {v}^{2} ) \frac{ρ}{E} \frac{{L}^{5}}{{T}^{2}} θ \times {f}^{2} \qquad ( 1 )$$

In this regard, a represents a coefficient of the shape of the movable portion, ν and ρ represent a Poisson's ratio and the density of a material of the movable portion, respectively, and E represents a Young's modulus of the material of the movable portion. L and T represent the length of a side perpendicular to the swinging axis of the movable portion, and the thickness of the movable portion, respectively. θ represents a deflection angle, and f represents a drive frequency.

In this regard, assume that the parameters other than the strain 5 caused by the inertia force in equation (1) and the drive frequency f are common in the structure 1, the structure 2, the structure 3, the structure 4, and the structure 5, and will be collectively referred to as a coefficient β. The coefficient β will be solved as equation (2). Equation (2) expresses the strain 5 caused by the inertia force of the movable portion at the optional drive frequency f. The structure of the smaller coefficient β is a structure of a less strain of the movable portion with respect to the inertia force.

$$β = \frac{δ}{{f}^{2}} \qquad ( 2 )$$

FIG. 14 is a view illustrating the rigidity of the movable portion of the rib structure illustrated in FIG. 13. More specifically, FIG. 14 is a graph obtained by analytically calculating the coefficient β from each of the structure 1, the structure 2, the structure 3, the structure 4, and the structure 5, and plotting the coefficient β.

As illustrated in FIG. 14, the structure 3 that indicates the movable portion according to the present embodiment indicates the lower coefficient β than those of the structure 1 and the structure 2. That is, the structure 3 is a structure of a less strain of the movable portion with respect to the inertia force than those of the structure 1 and the structure 2.

The structure 4 that indicates the movable portion according to the second embodiment indicates the lower coefficient β than those of the structure 1 and the structure 2. That is, the structure 4 is a structure of a less strain of the movable portion with respect to the inertia force than those of the structure 1 and the structure 2.

The structure 5 that indicates the movable portion according to the third embodiment indicates the lower coefficient β than those of the structure 1 and the structure 2. That is, the structure 5 is a structure of a less strain of the movable portion with respect to the inertia force than those of the structure 1 and the structure 2.

Furthermore, upon comparison among the structure 3, the structure 4, and the structure 5, the structure 4 indicates the lower coefficient β than that of the structure 5, and the structure 3 indicates the lower coefficient β than those of the structure 4 and the structure 5. That is, the structure 4 is a structure of a less strain of the movable portion with respect to the inertia force than that of the structure 5. Furthermore, the structure 3 is a structure of a less strain of the movable portion with respect to the inertia force than those of the structure 4 and the structure 5.

Next, a function of the present embodiment will be described. As described above, the first movable plate 212A and the second movable plate 214A are bonded such that the reflecting surface 216 and the driving force generating surface 218 are disposed outside the opposite sides. Consequently, the driving force generating surface 218 can be formed to have high flatness.

Furthermore, as described above, the movable portion 210A of the optical deflector 200A according to the present embodiment has a less strain of the movable portion caused by the inertia force compared to the solid movable portion without ribs, and the movable portion in which the first movable plate and the second movable plate each have both of the ribs that extend in the direction parallel to the swinging axis of the elastic members and the ribs that extend in the direction perpendicular to the swinging axis of the elastic members. Hence, the rigidity against the inertia force is high.

Furthermore, the elastic members 222 and 224 are formed in the same layer as that of the second movable plate 214A. Consequently, compared to a configuration where the elastic members 222 and 224 are formed for the first movable plate 212A having the reflecting surface 216, reaction forces of the elastic members 222 and 224 transmitting to the reflecting surface 216 are reduced.

As described above, the optical deflector 200A according to the present embodiment employs the configuration where the first ribs 232A are formed in the back surface of the reflecting surface 216 of the first movable plate 212A and the second ribs 234A are formed in the back surface of the driving force generating surface 218 in the structure of the movable portion 210A, and the first ribs 232A and the second ribs 234A three-dimensionally intersect each other. This allows the dynamic strain of the reflecting surface 216 caused by the inertia force to be suppressed, and the reflecting surface 216 of the movable portion 210A and the back surface, i.e., the driving force generating surface 218, to be planar surfaces. Furthermore, forming the elastic members 222 and 224 in the same layer as that of the second movable plate 214A allows a dynamic strain of the reflecting surface 216 caused by the reaction forces of the elastic members 222 and 224 to be suppressed.

Next, a modification will be described. As illustrated in FIG. 4, the second movable plate 214A has a rectangular shape in the present embodiment, yet is not limited to this and may have other shapes such as an elliptical shape.

### Second Embodiment

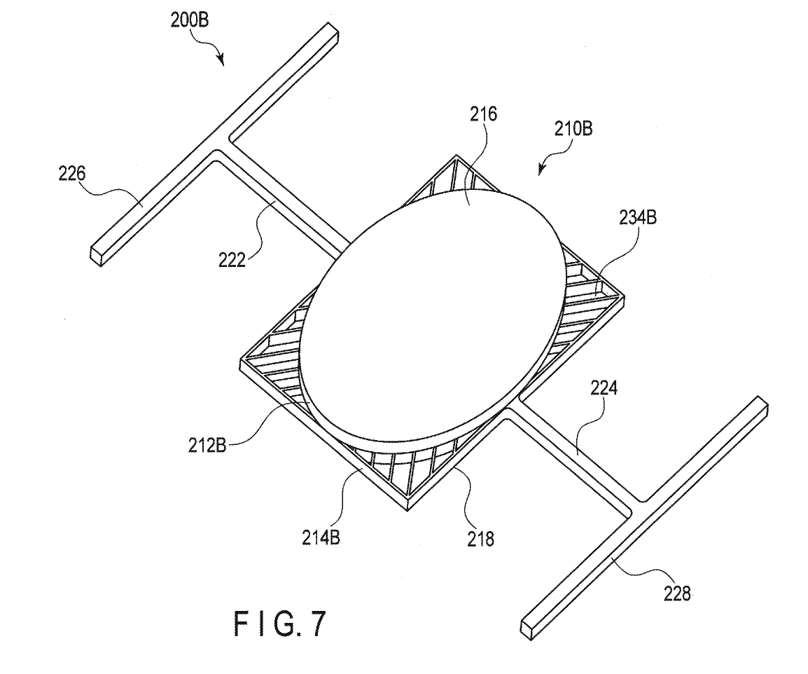

Next, an optical deflector according to the second embodiment will be described. FIGS. 7 to 9 are views illustrating a perspective configuration of an optical deflector 200B according to the second embodiment. First, the configuration will be described. As illustrated in FIG. 7, this optical deflector 200B includes at least a movable portion 210B having a reflecting surface 216, elastic members 222 and 224 configured to swingably support the movable portion 210B about a swinging axis, and support portions 226 and 228 supporting the elastic members 222 and 224. The movable portion 210B includes a first movable plate 212B and a second movable plate 214B.

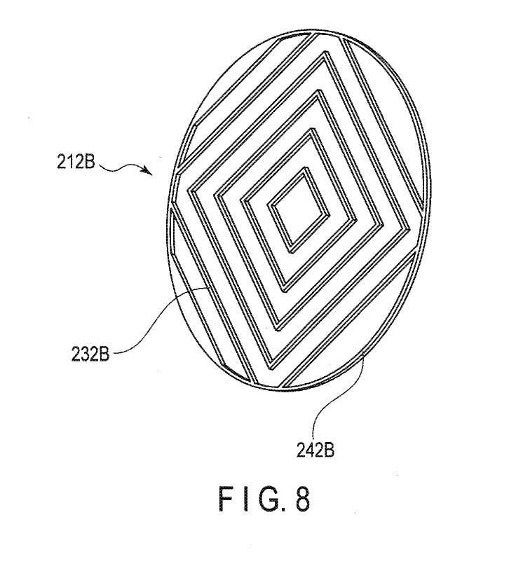

Furthermore, as illustrated in FIG. 8, the first movable plate 212B has the reflecting surface 216 having an elliptical outline, and first ribs 232B that are formed on a back surface of the elliptical reflecting surface 216. The first ribs 232B protrude from the back surface of the reflecting surface 216, and extend in directions parallel to lines connecting intersection points of an outer circumference and a major axis of the elliptical reflecting surface 216 and intersection points of the outer circumference and a minor axis of the elliptical reflecting surface 216.

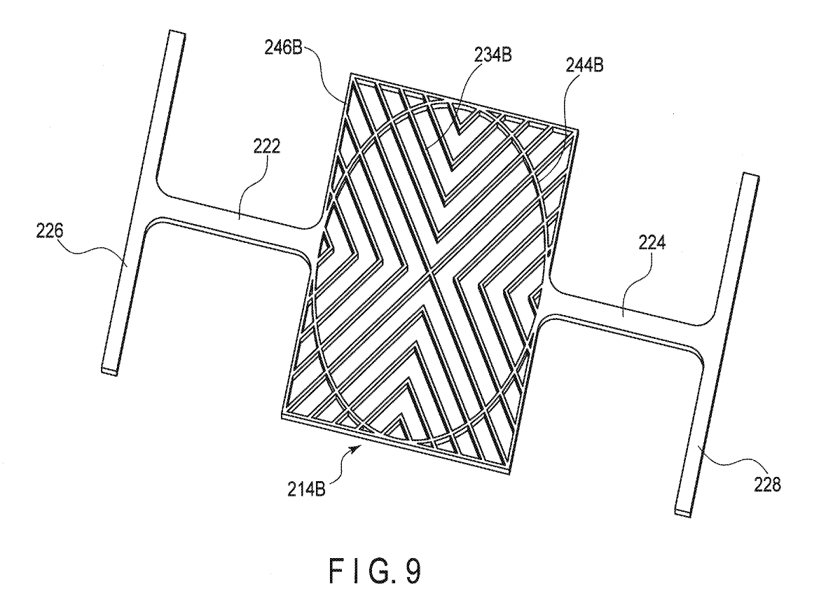

Furthermore, as illustrated in FIG. 9, the second movable plate 214B is formed by the same layer as the elastic members 222 and 224. Furthermore, the second movable plate 214B has a driving force generating surface 218, and second ribs 234B that are formed on the back surface of the driving force generating surface 218. The second ribs 234B protrude from the back surface of the driving force generating surface 218, and extend in directions parallel to diagonal lines of the rectangular shape that is circumscribed about the elliptical reflecting surface 216.

The first ribs 232B and the second ribs 234B three-dimensionally intersect each other, and part of the first ribs 232B and part of the second ribs 234B are bonded.

Furthermore, the first movable plate 212B is a three-dimensional body having an end face that corresponds with an outline shape of the elliptical reflecting surface 216, and has a first frame 242B that is formed at an outer circumference portion of the outline shape. The first frame 242B protrudes from the back surface of the reflecting surface 216 similar to the first ribs 232B.

The second movable plate 214B has a second frame 244B that is bonded with the first frame 242B. That is, the second frame 244B has the same elliptical outline shape as that of the first frame 242B. Furthermore, the second movable plate 214B is a three-dimensional body having an end face that corresponds with a square outline shape, and has a third frame 246B that is formed at an outer circumference portion of the outline shape. The second frame 244B and the third frame 246B protrude from the back surface of the driving force generating surface 218 similar to the second ribs 234B.

Furthermore, although not illustrated, a driving force generating member is formed on the driving force generating surface 218.

In addition, a rib structure, rigidity, a function, and an effect of the movable portion 210B are the same as those of the first embodiment, and therefore description thereof will be omitted.

### Third Embodiment

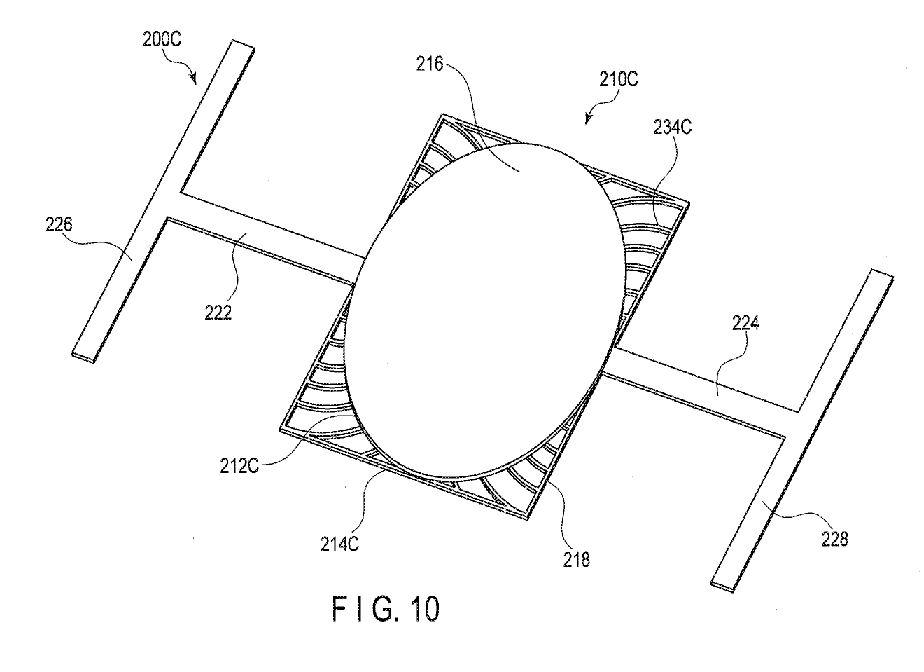

Next, an optical deflector according to the third embodiment will be described. FIGS. 10 to 12 are views illustrating a perspective configuration of an optical deflector 200C according to the third embodiment. First, the configuration will be described. As illustrated in FIG. 10, this optical deflector 200C includes at least a movable portion 210C having a reflecting surface 216, elastic members 222 and 224 configured to swingably support the movable portion 210C about a swinging axis, and support portions 226 and 228 supporting the elastic members 222 and 224. The movable portion 210C includes a first movable plate 212C and a second movable plate 214C.

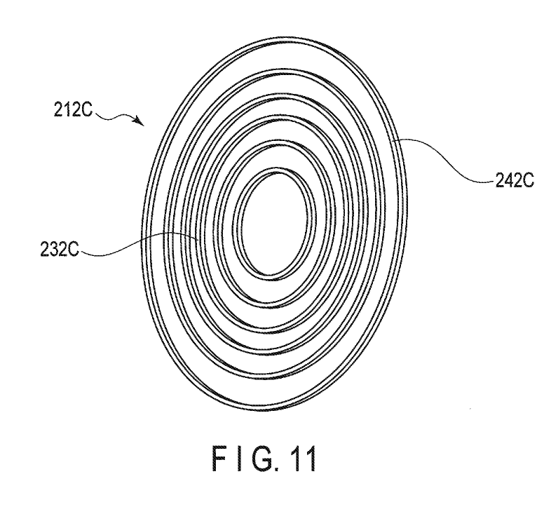

Furthermore, as illustrated in FIG. 11, the first movable plate 212C has the reflecting surface 216 having an elliptical outline, and first ribs 232C that are formed on a back surface of the elliptical reflecting surface 216. The first ribs 232C extend along, for example, ellipses concentrically disposed at the center of the reflecting surface 216.

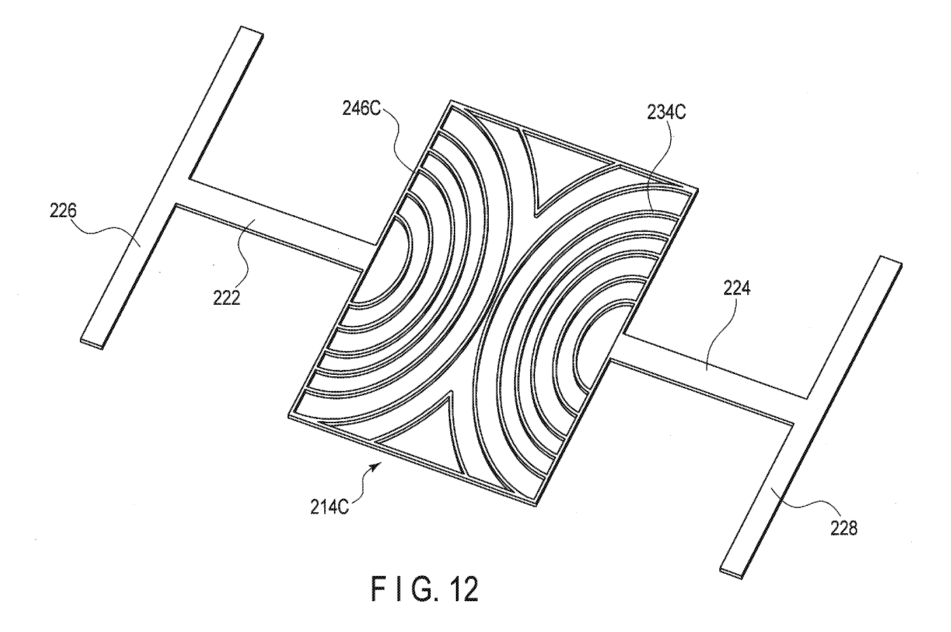

Furthermore, as illustrated in FIG. 12, the second movable plate 214C is formed by the same layer as the elastic members 222 and 224. Furthermore, the second movable plate 214C has a driving force generating surface 218, and second ribs 234C that are formed on the back surface of the driving force generating surface 218. The second ribs 234C extend in curved shapes. The curves may each be a quadratic curve such as an ellipse, a parabola or a hyperbola, yet is not limited to these and may be other curves.

The first ribs 232C and the second ribs 234C three-dimensionally intersect each other, and part of the first ribs 232C and part of the second ribs 234C are bonded. Furthermore, the first movable plate 212C is a three-dimensional body having an end face that corresponds with an outline shape of the elliptical reflecting surface 216, and has a first frame 242C that is formed at an outer circumference portion of the outline shape. The first frame 242C protrudes from the back surface of the reflecting surface 216 similar to the first ribs 232C.

Furthermore, the second movable plate 214C is a three-dimensional body having an end face that corresponds with a square outline shape, and has a third frame 246C that is formed at an outer circumference portion of the outline shape. The third frame 246C protrudes from the back surface of the driving force generating surface 218 similar to the second ribs 234C. The first frame 242C three-dimensionally intersects the second rib 234C, and is bonded with the second rib 234C at intersection points.

Furthermore, although not illustrated, a driving force generating member is formed on the driving force generating surface 218.

In addition, a rib structure, rigidity, a function, and an effect of the movable portion 210C are the same as those of the first embodiment, and therefore description thereof will be omitted.

(Modification of Combination of Ribs)

In the first embodiment to the third embodiment, the first movable plate 212A and the second movable plate 214A are combined, the first movable plate 212B and the second movable plate 214B are combined, and the first movable plate 212C and the second movable plate 214C are combined, respectively. However, these movable plates are not limited to these combinations, and may be exchanged and combined. For example, the first movable plate 212A having the first ribs 232A may be combined with the second movable plate 214B having the second ribs 234B or the second movable plate 214C having the second ribs 234C. Similarly, the first movable plate 212B having the first ribs 232B may be combined with the second movable plate 214A having the second ribs 234A or the second movable plate 214C having the second ribs 234C Furthermore, the first movable plate 212C having the first ribs 232C may be combined with the second movable plate 214A having the second ribs 234A or the second movable plate 214B having the second ribs 234B

### Fourth Embodiment

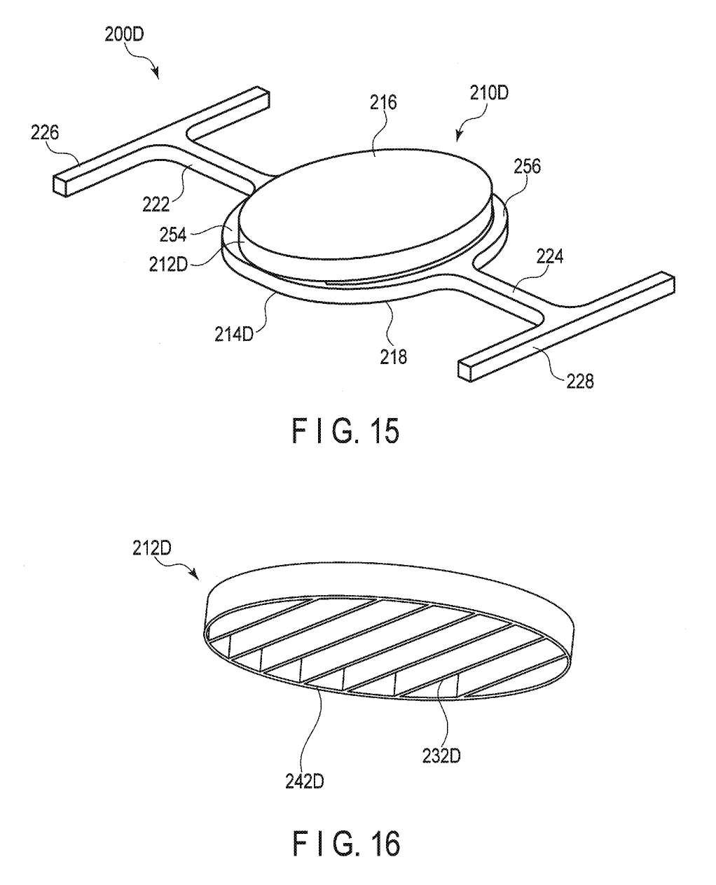

Next, an optical deflector according to the fourth embodiment will be described. FIGS. 15 to 17 are views illustrating a perspective configuration of an optical deflector 200D according to the fourth embodiment. First, the configuration will be described. As illustrated in FIG. 15, this optical deflector 200D includes at least a movable portion 210D having a reflecting surface 216, elastic members 222 and 224 configured to swingably support the movable portion 210D about a swinging axis, and support portions 226 and 228 supporting the elastic members 222 and 224. The movable portion 210D includes a first movable plate 212D and a second movable plate 214D.

Furthermore, as illustrated in FIG. 16, the first movable plate 212D has the reflecting surface 216 having an elliptical outline, and first ribs 232D that are formed on a back surface of the elliptical reflecting surface 216. The first ribs 232D protrude from the back surface of the reflecting surface 216, and extend in a direction parallel to the swinging axis of the elastic members 222 and 224.

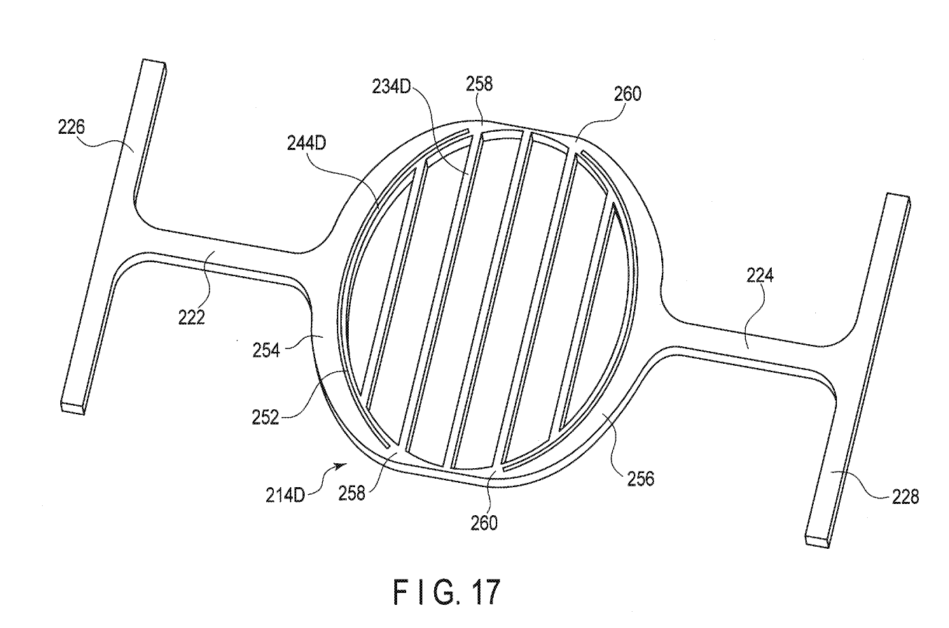

Furthermore, as illustrated in FIG. 17, the second movable plate 214D is formed by the same layer as the elastic members 222 and 224. Furthermore, the second movable plate 214D has a driving force generating surface 218, and second ribs 234D that are formed on the back surface of the driving force generating surface 218. The second ribs 234D protrude from the back surface of the driving force generating surface 218, and extend in the direction perpendicular to the swinging axis of the elastic members 222 and 224.

The first ribs 232D and the second ribs 234D three-dimensionally intersect each other, and part of the first ribs 232D and part of the second ribs 234D are bonded.

Furthermore, the first movable plate 212D is a three-dimensional body having an end face that corresponds with an outline shape of the elliptical reflecting surface 216, and has a first frame 242D that is formed at an outer circumference portion of the outline shape.

Furthermore, the second movable plate 214D includes a movable plate main body 252 to which the first movable plate 212D is bonded, stress transmission prevention portions 254 and 256 that are connected with the elastic members 222 and 224, respectively, and connection portions 258 and 260 connecting the movable plate main body 252 and the stress transmission prevention portions 254 and 256, respectively.

The movable plate main body 252 has a second frame 244D that is bonded with the first frame 242D. That is, the second frame 244D has the same elliptical outline shape as that of the first frame 242D. Furthermore, the movable plate main body 252 has the same elliptical outline shape as that of the first movable plate 212D. Hence, the movable plate main body 252 is a three-dimensional body having an end face that corresponds with the elliptical outline shape, and the second frame 244D is formed at an outer circumference portion of the outline shape. The stress transmission prevention portions 254 and 256, and the elastic members 222 and 224 are apart from the first frame 242D and the second frame 244D.

The stress transmission prevention portions 254 and 256 are apart from the movable plate main body 252. The stress transmission prevention portions 254 and 256 extend along the outline shape of the movable plate main body 252.

Connection portions 258 and 260 are located near intersection points of an axis that passes the center of the reflecting surface 216 and is perpendicular to the swinging axis of the elastic members 222 and 224, and end portions of the reflecting surface 216. More specifically, the connection portions 258 and 260 pass the intersection point of the axis that is perpendicular to the swinging axis and the end portion of the reflecting surface 216, and are provided by extending the second frame 244D in a swinging axis direction.

In addition, although not illustrated, a driving force generating member such as a drive coil is formed on the driving force generating surface 218.

In addition, a rib structure, rigidity, a function, and an effect of the movable portion 210D are the same as those of the first embodiment, and therefore description thereof will be omitted.

A function unique to the present embodiment that differs from the first embodiment will be described below. As described above, the second movable plate 214D includes the movable plate main body 252 to which the first movable plate 212D is bonded, the stress transmission prevention portions 254 and 256 that are connected with the elastic members 222 and 224, and the connection portions 258 and 260 that connect the movable plate main body 252 and the stress transmission prevention portions 254 and 256. The stress transmission prevention portions 254 and 256 are apart from the movable plate main body 252. Furthermore, the first movable plate 212D is a three-dimensional body having an end face that corresponds with an outline shape of the elliptical reflecting surface 216, and has the first frame 242D that is formed at an outer circumference portion of the outline shape. The movable plate main body 252 has the second frame 244D that is bonded with the first frame 242D. The stress transmission prevention portions 254 and 256, and the elastic members 222 and 224 are apart from the first frame 242D and the second frame 244D.

Consequently, the stress transmission prevention portions 254 and 256 trap reaction forces of the elastic members 222 and 224 during deflection, which reduces the reaction forces of the elastic members 222 and 224 transmitting to the movable portion 210D.

Furthermore, the connection portions 258 and 260 are formed at ends of the second movable plate 214D. Hence, the ends of the second movable plate 214D at which a moment of an inertia of the second movable plate 214D maximizes, and the connection portions 258 and 260 that are supporting points match. Hence, it is possible to minimize the moment of the inertia to be applied to the movable plate end during deflection.

Furthermore, the stress transmission prevention portions 254 and 256 are formed along the outline shape of the reflecting surface 216, so as to suppress an increase in the moment of the inertia of the optical deflector 200D.

As described above, the optical deflector 200D according to the present embodiment includes the stress transmission prevention portions 254 and 256 and the connection portions 258 and 260 between the elastic members 222 and 224 and the movable plate main body 252, so that it is possible to suppress a dynamic strain of the reflecting surface caused by the stresses of the elastic members 222 and 224.

In addition, the present invention is by no means limited to the above embodiments, and can be variously modified without deviation from the spirit of the embodiments at the stage of implementation. Furthermore, each embodiment may be carried out in combination as appropriate as much as possible, and an effect obtained by the combination can be obtained in this case. Furthermore, the above embodiments include inventions of various stages, and various inventions can be extracted based on an adequate combination of components to be disclosed. For example, even though some components are removed from all components disclosed in the embodiments, it is possible to solve the problems described in the summary and, when it is possible to obtain an effect described in the effects of the embodiments, it is possible to extract a configuration from which these components are removed as the invention.

The embodiments have described a configuration where the first movable plate and the second movable plate each have ribs. However, the first movable plate and the second movable plate may be each configured to have a single rib that is bent back and extends or extends in a spiral shape.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical deflector comprising:
a movable portion having a reflecting surface;
an elastic member configured to swingably support the movable portion about a swinging axis; and
a support portion configured to support the elastic member, wherein
the movable portion includes a first movable plate including the reflecting surface, and a second movable plate including a driving force generating surface,
the first movable plate includes at least one first rib formed on a back surface of the reflecting surface,
the second movable plate includes at least one second rib formed on a back surface of the driving force generating surface,
the first rib and the second rib being configured to intersect each other, and
part of the first rib and part of the second rib are bonded.

2. The optical deflector according to claim 1, wherein
the at least one first rib includes the first ribs, and
the at least one second rib includes the second ribs.

3. The optical deflector according to claim 2, wherein
the first ribs extend in a direction parallel to the swinging axis of the elastic member.

4. The optical deflector according to claim 2, wherein
the reflecting surface has an elliptical outline, and
the first ribs extend in directions parallel to lines connecting intersection points of an outer circumference and a major axis of the reflecting surface and intersection points of the outer circumference and a minor axis of the reflecting surface.

5. The optical deflector according to claim 2, wherein
the reflecting surface has an elliptical outline, and
the first ribs extend along concentrically disposed ellipses.

6. The optical deflector according to claim 3, wherein the second ribs extend in a direction perpendicular to the swinging axis of the elastic member.

7. The optical deflector according to claim 3, wherein the second ribs extend in directions parallel to diagonal lines of a rectangular shape that is circumscribed about the reflecting surface.

8. The optical deflector according to claim 3, wherein the second ribs extend curvilinearly.

9. The optical deflector according to claim 2, wherein
the second movable plate includes a movable plate main body to which the first movable plate is bonded, a stress transmission prevention portion connected with the elastic member, and a connection portion connecting the movable plate main body and the stress transmission prevention portion, and
the stress transmission prevention portion is apart from the movable plate main body.

10. The optical deflector according to claim 9, wherein
the first movable plate is a three-dimensional body having an end face that corresponds with an outline shape of the reflecting surface, and has a first frame formed at an outer circumference portion of the outline shape,
the movable plate main body has a second frame bonded with the first frame, and
the elastic member and the stress transmission prevention portion are apart from the first frame and the second frame.
